(19) United States
(12) Patent Application Publication
(10) Pub. No.: US 2026/0229228 A1
(43) Pub. Date: Aug. 6, 2026

(54) Method and device for generating weighted text output and/or speech output based on input data

(71) Applicant: FORBENCAP GmbH, Sonthofen (DE)

(72) Inventor: Stefan GÖTZ, Forstern (DE)

(73) Assignee: FORBENCAP GmbH, Sonthofen (DE)

(21) Appl. No.: 19/530,853

(22) Filed: Feb. 5, 2026

(30) Foreign Application Priority Data
Feb. 6, 2025 (DE) 10 2025 104 454.6

(51) Int. Cl. G10L 15/16; G10L 15/18

(52) U.S. Cl. CPC G10L 15/16; G10L 15/1815

(57) ABSTRACT

A method for automatically generating a weighted text output and/or speech output based on input data. In one approach the method may include: providing graphical input data having objects via an input interface of at least one machine learning model; providing labeling information for at least one of the objects and at least one weighting information for at least one of the objects and/or at least one of the labeling information via a further input interface of the at least one machine learning model as additional metadata to the graphical input data; and processing the input data, the labeling information and the at least one weighting information by the at least one machine learning model to generate the text output and/or speech output weighted on the basis of the at least one weighting information.

### CROSS-REFERENCE TO RELATED APPLICATION(S)

This application claims the benefit of German Application No. 10 2025 104 454.6 filed Feb. 6, 2025, which is incorporated herein by reference in its entirety.

### TECHNICAL FIELD

The disclosure relates to a method and device for automatically generating a weighted text output and/or speech output based on input data.

### BACKGROUND

The automation of text document creation has gained importance due to the increasing development of large language models, such as the various generations of Generative Pre-Trained Transformers (GPT). These advanced technologies make it possible to transform simple and sometimes unstructured information into understandable and comprehensible texts. The use of large language models (LLMs) has played a central role in this development. These models work on the basis of complex statistical methods and use probabilities to predict the next word based on the previous words. This results in text passages that are coherent and meaningful in some cases, enabling a wide range of applications.

A remarkable innovation in this area is the ability of the latest GPT generation, or other combinations of convolutional neural networks with transformers and encoder and, in particular, decoder structures, to generate text based on image inputs. This feature greatly expands the possibilities of text automation by enabling visual information to be translated into abstract descriptions. Methods such as segmentation and classification are crucial here in order to create relevant text embeddings, which are then used by LLMs to produce coherent and, in some cases, meaningful text. This represents a step forward in the processing and interpretation of visual data and opens up new fields of application in areas such as image description and analysis.

Despite these impressive advances, challenges remain. In particular, the ability to generate texts that have a deeper meaning and go beyond purely semantic links is not yet fully developed. While LLMs are capable of creating grammatically correct and contextually appropriate sentences, they often lack deeper logical consistency and an understanding of complex relationships. These gaps are particularly evident when it comes to writing longer and more sophisticated texts that go beyond simply stringing together pieces of information.

The further development and refinement of these models therefore requires not only an improvement of the underlying algorithms, but also a deeper integration of knowledge and context.

### SUMMARY

It is an object of the disclosure to specify an improved method and/or an improved device for this purpose.

The object is achieved by a method according to the features of patent claim 1. The object is achieved by a device according to the features of patent claim 15.

According to a first aspect, a method for automatically generating a weighted text output and/or speech output based on input data is proposed. The method comprising:
providing graphical input data comprising objects via an input interface to at least one machine learning model (ML model);
providing labeling information for at least one of the objects and at least one weighting information for at least one of the objects and/or at least one of the labeling information via a further input interface of the at least one machine learning model as additional metadata to the graphical input data, wherein the labeling information comprises a respective object description and/or classification and/or interaction information between objects, and wherein the at least one weighting information has or defines a ranking and/or an importance and/or a sequence for the at least one of the objects and/or for the at least one of the labeling information; and
processing the input data, the labeling information, and the at least one weighting information by the at least one machine learning model to generate the text output and/or speech output weighted on the basis of the weighting information. The method preferably comprises generating the text output and/or speech output weighted on the basis of the weighting information.

A computer-implemented method for automatically generating a weighted text output and/or speech output based on input data is proposed, wherein the method comprises: providing graphical input data comprising objects via an input interface to at least one machine learning model; providing labeling information for at least one of the objects and at least one weighting information for at least one of the objects and/or at least one of the labeling information via a further input interface of the at least one machine learning model, separate from the input interface, as additional metadata to the graphical input data, wherein (a) the labeling information comprises a respective object description and/or object classification and/or interaction information between objects, and (b) the at least one weighting information defines a ranking and/or importance and/or sequence for the at least one of the objects and/or for the at least one of the labeling information as machine-readable metadata information; processing the graphical input data, the labeling information, and the at least one weighting information by the at least one machine learning model, wherein the at least one weighting information is taken into account as control information during processing in order to control output generation in accordance with the weighting information; and generating the weighted text output and/or speech output by the at least one machine learning model, wherein the weighted text output and/or speech output takes into account objects and/or labeling information in accordance with the weighting information at least to the extent that a prioritized output and/or a sequence formation and/or a suppression of at least one object and/or at least one labeling information takes place.

Furthermore, a method for automatically generating a weighted text output and/or speech output based on input data, computer-implemented, is preferred, wherein the method comprises: providing graphical input data comprising at least one object via a first input interface to at least one machine learning model; providing labeling information for at least one object and at least one weighting information for at least one object and/or at least one of the labeling pieces of information via a second input interface separate from the first input interface to the at least one machine learning model as additional metadata to the graphical input data, wherein (a) the labeling information comprises at least one object description and/or object classification and/or interaction information between objects, and (b) the weighting information defines a ranking and/or importance and/or sequence for the at least one object and/or for the at least one labeling information; processing the graphical input data as well as the labeling information and the at least one weighting information by the at least one machine learning model, wherein the at least one weighting information is used in the machine learning model as a technical input parameter to control at least one processing of the graphical input data and/or the labeling information depending on the weighting information, in particular by (i) feature representations, feature channels, and/or feature maps extracted from the graphical input data are amplified and/or attenuated, and/or (ii) a selection, suppression, prioritization, and/or sequencing of the objects and/or labeling information to be processed is performed, and/or (iii) adjusting parameters of fusion, attention, or decoder processing depending on the weighting information; and generating the weighted text output and/or speech output by the at least one machine learning model based on the processing according to the preceding processing section, wherein the weighted text output and/or speech output outputs and/or hides objects and/or labeling information in accordance with the weighting information and/or outputs them in a sequence defined by the weighting information.

Also preferred is a method for automatically generating a weighted text output and/or speech output based on input data, computer-implemented, wherein the method performs: providing graphical input data comprising at least one object via a first input interface to a machine learning model, wherein the first input interface is associated with a first input layer of the machine learning model, which is designed to process image, video, and/or vector data; providing labeling information for at least one object and at least one weighting information for at least one object and/or at least one of the labeling pieces of information to the machine learning model via a second input interface separate from the first input interface, wherein the second input interface is assigned to a second input layer of the machine learning model, which is separate from the first input layer and is designed to process numerical and/or textual metadata, wherein (a) the labeling information comprises at least one object description and/or object classification and/or interaction information between objects, and (b) the weighting information comprises at least one machine-readable numerical weighting value that defines a ranking and/or importance and/or sequence for the at least one object and/or for the at least one labeling information; processing the graphical input data in the first input layer and the labeling information and the weighting information in the second input layer, and merging the feature representations generated thereby in a fusion layer of the machine learning model; wherein, during the merging, the numerical weighting information is used as a technical control parameter to execute a gating mechanism and/or a modulation function in the machine learning model, which object-wise amplifies and/or attenuates feature channels of the feature representations generated from the graphical input data, depending on the at least one numerical weighting value; and generating the weighted text output and/or speech output by the machine learning model on the basis of the merged feature representations, wherein the weighted text output and/or speech output prioritizes and/or hides objects and/or labeling information according to the numerical weighting information and/or outputs them in a sequence defined by the weighting information.

The descriptions provided apply in a similar form to the claimed device without being mentioned redundantly for it.

The method is a computer-implemented method.

It is understood that the steps according to the invention and further optional steps do not necessarily have to be performed in the order shown, but can also be performed in a different order. Furthermore, further intermediate steps may be provided. The individual steps may also comprise one or more sub-steps without departing from the scope of the method according to the invention.

According to a second aspect, a device for automatically generating a weighted text output and/or speech output based on input data is proposed. The device has an evaluation and computing device that is set up to perform at least the following steps:
providing graphical input data comprising objects via a first input interface to at least one machine learning model;
providing labeling information for at least one of the objects and at least one weighting information for at least one of the objects and/or at least one of the labeling information via a further input interface of the at least one machine learning model as additional metadata to the graphical input data, wherein the labeling information comprises a respective object description- and/or classification and/or interaction information between objects, and wherein the at least one weighting information defines a ranking and/or an importance and/or a sequence for the at least one of the objects and/or for the at least one of the labeling information; and
Processing the input data, the labeling information, and the at least one weighting information by the at least one machine learning model to generate the text output and/or speech output weighted on the basis of the weighting information.

The explanations given for the method apply to the device accordingly and vice versa. It is understood that linguistic variations of features formulated in terms of the method can be reformulated for the device in accordance with customary linguistic practice without such formulations having to be explicitly listed here.

The weighting information preferably describes additional meta-information that is assigned to one or more objects and their associated labeling information and preferably determines their relative importance, order, and/or priority in the context of processing by the machine learning model. The weighting information preferably comprises a ranking, an importance, and/or a sequence of the objects and/or labeling information. The ranking preferably specifies a hierarchical order based on their relevance and/or importance, so that one object can preferably be classified as more important than another and is preferably given preferential treatment and/or mentioned first or not mentioned at all in the generated text or speech output. The importance is preferably expressed by a rating measure that determines the relative relevance of an object and/or labeling information and is preferably represented by a weighting scale that influences how strongly the object is taken into account in the output. The sequence preferably specifies a defined order of the objects and/or labeling information, which determines the sequence in which they are processed or displayed in the output, so that the information is preferably presented in a structured manner in a coherent text and/or speech output. The weighting information preferably directly influences the result of the text or speech output by determining which content is preferably prioritized or displayed preferentially, so that a meaningfully structured, relevant, and/or context-dependent output is preferably generated.

The input data may preferably comprise image and/or video data and/or vector data. The input data may comprise pixel information or vector information and/or vector graphics information and/or multidimensional (in particular three-dimensional) geometry or vector graphics information. The input data can be generated by user input via an input interface or via structured voice input or voice input to be structured by a processing instance. The input data can comprise metadata or meta-information generated by user input via an input interface. User input via such a user interface preferably comprises graphical input and/or textual and/or auditory input. The input data may preferably also comprise text data, for example, a keyword list or similar text data.

The system comprises a first input interface for graphical input data and a further input interface, separate from the first input interface, for metadata, in particular labeling information and/or weighting information. The two input interfaces can be technically implemented as data paths that are independent of each other, wherein each data path may comprise its own data validation, its own buffering module, and/or its own preprocessing unit. Preferably, the data streams are not mixed before entering the machine learning model. The first input interface may lead to a first input layer of the model, which processes exclusively image, video, and/or vector data. The second input interface may lead to an input layer that is separate from the first input layer and that processes exclusively numerical and/or textual metadata. The input layers may be separated from each other at the hardware level and/or software level and enable differentiated, modality-specific model processing. The separate input interfaces may be implemented in hardware as separate ports, separate bus lines, or dedicated memory areas. The first input layer may perform image normalization, noise reduction, or compression, while the second input layer performs numerical scaling, tokenization, or feature normalization. The term “further input interface” is to be understood to mean that, in addition to the input interface for providing the graphical input data, the machine learning model comprises a further, separate input interface for providing the at least one weighting information and the labeling information.

Preferably, providing the labeling information and at least one weighting information enables flexible and adaptive control of the output of the machine learning model without requiring readjustment or time-consuming retraining of the model. Preferably, this allows the user to influence the weighting of individual objects and/or their classifications at any time during the inference phase, thereby specifically controlling the relevance of certain features in the output. Preferably, this achieves a high degree of adaptability by allowing the machine learning model to respond dynamically to changing requirements and/or individual preferences of the user without the need for in-depth intervention in the underlying model parameters. Preferably, this option significantly improves the efficiency and flexibility of the machine learning model, as the output quality can be optimized without additional training processes through the targeted weighting of objects or their interactions.

Preferably, the provision of graphical input data comprising objects via an input interface comprises at least one machine learning model, the processing of visual information in the form of images, videos, and/or other graphical representations, wherein these objects comprise those that can be recognized and further processed by the machine learning model. Preferably, this provision takes place via an interface that enables digital transmission of the data, for example, through direct integration into a system that processes real-time data or by uploading previously captured graphical input data.

Preferably, the provision of labeling information about the objects and at least one at least one weighting information about at least one of the objects and/or at least one of the pieces of labeling information via a further input interface of the at least one machine learning model comprises a supplementary assignment of metadata to the captured objects. Preferably, this labeling information includes a description and/or classification of the objects as well as interaction information that reflects relationships between different objects within the graphical input data. Preferably, the weighting information is provided in a manner that enables targeted control of the weighting of individual objects or their labels within the processing by the machine learning model, for example, by prioritizing relevant features or adjusting the weighting to specific use cases.

Preferably, the respective input interface can be designed as a digital interface that enables direct transfer of data to the machine learning model, for example, via an API, a data stream interface, and/or a file import function. Preferably, the input interface can also comprise a sensor-based acquisition unit that acquires graphical input data post hoc, for example, after temporary storage or preprocessing, including event detection or decomposition or marking of time periods, or even in real time, and forwards it directly to the machine learning model. For example, the graphical data of a sensor-based acquisition unit can be temporarily stored in its entirety or in time-limited units, for example, initial intervals. Furthermore, a ring buffer can also enable temporary storage with a continuous data stream. The graphical data from a sensor-based recording unit can, for example, be provided with temporal or spatial markers by a preprocessing unit, for example, based on content, for example, specific events in the graphical data, or based on further signal data such as triggers or data, or be divided or broken down into temporal intervals (epochs). The latter epochs can, for example, be transferred directly or indirectly to the machine learning model as units for further processing. Events can be, for example, accidents that are detected from the graphical data or, alternatively, detected from acoustic, i.e., separate signals, or originate from externally provided information and time stamps, for example, also from vehicle crash detections. Furthermore, traffic light phases can be marked or detected and correspondingly divided into epochs from the graphical data itself or from additional data, such as traffic light switching data. Furthermore, the marking and/or division into spatial areas can be performed, for example, on the basis of detected object boundaries, segments, or parts of objects or elements that are detected on the basis of the graphic data itself or through additional data. The spatial recognition or division of the graphical data can be performed, for example, by signal processing such as the recognition of color or grayscale changes, by grouping similar pixel values, or by machine preprocessing such as pattern recognition, including neural networks with at least one convolution layer. Preferably, the input interface can also be designed as a preprocessing unit that performs initial structuring or filtering of the input data before it is made available to the machine learning model.

Preferably, the respective input interface can also be designed as a respective input layer of the machine learning model by enabling direct integration of the graphical input data into the neural network so that the data is available in a format optimized for model processing. Preferably, this input layer for providing the graphical input data can be designed to process different data types such as images, videos, and/or vector-based representations and convert them into latent feature representations. Preferably, this input layer for providing the weighting information and the labeling information can be designed to process various data types, such as numerical and/or textual data and/or audio data, and convert them into latent feature representations. Preferably, the respective input layer may also have mechanisms for normalizing, scaling, or feature extraction of the input data to ensure efficient and optimized processing by the machine learning model.

The at least one weighting information can preferably be provided to the machine learning model together with the input data. The at least one weighting information is preferably provided via a separate input interface of the machine learning model. The input interface for providing the input data thus preferably differs from the further input interface for providing the at least one weighting information and the at least one labeling information. The at least one weighting information can also be generated by a user using the further input interface based on the input data. The at least one weighting information can be generated by a user via textual, numerical, and/or voice input. Furthermore, the at least one weighting information can be generated in any graphical, haptic, and/or other manual manner, for example, via a touch screen or with a mouse, e.g. also in a specific order. The user can also select an object or labeling information at only one point, whereby, for example, a region growing algorithm then preferably extends the selected area to an entire contiguous element. The at least one weighting information can also be generated semi-automatically or automatically on the basis of meta-information or other weighting criteria relating to the input data and provided to the machine learning model via the additional separate input interface in addition to the graphical input data. The at least one weighting information can also be specified by coloring according to a predetermined scale and/or by marking according to a predetermined marking scheme. The at least one weighting information can also be generated by a user's voice input, for example, via a microphone, and be based on the user using, for example, keywords and/or key terms and/or keyword sequences to thereby determine a weighting.

An object in image and/or video data is preferably defined by a group of pixels that together form a recognizable pattern and/or shape. Preferably, the objects comprise one or more geometric elements. Preferably, the objects comprise graphic objects. Thus, an object can be defined as a physical object, a subject, and/or at least one segment in the background comprised in the image and/or video data. An object in vector data is preferably defined by geometric primitives that can be described by mathematical equations. These can preferably be physical objects, subjects, and/or other mathematically detectable segments or sections or parts of the input data.

The weighting information can be encoded as explicit numerical values assigned to a pixel or group of pixels in a region marked by the user. These values do not represent linguistic or semantic commands, but rather machine-readable control variables that are directly incorporated into the model's mathematical calculation operations. The numerical weighting values can be used by the model to modify attention priorities by influencing the weighting of key-value pairs in the model's attention layers. This technically prioritizes the processing of certain image areas. In contrast to prompt-based control systems, in which users attempt to set model priorities indirectly via natural language, the weighting information in the present method can be used as technical input parameters with a direct influence on internal neural computing units. This represents a structural control mechanism anchored in the model. Numerical weighting control can significantly improve model performance as measured by objective technical metrics (e.g., text consistency, error rate, latency). The technical effect of the weighting information can be mathematically described, by a channel-specific modulation function in which the feature map F(x, y, c) of a channel c adjusted by multiplication with a weight vector w(c) for example, can be. The resulting feature map F′(x, y, c)=F(x, y, c)·w(c) can cause a weighted amplification or attenuation of individual object features already at the feature extraction level. This modulation takes place preferably completely without semantic interpretation of the data and represents purely technical signal processing.

Labeling information preferably refers to metadata or additional information assigned to an object in a data set. This information preferably serves to uniquely identify the object and/or distinguish it from its surroundings and/or background and/or assign a relevance measure and/or provide relevant details about its properties, functionality, condition, and/or relationship to other objects. The labeling information can preferably be generated by a user or user input, for example using typical digital input media but also by handwriting, and provided to the machine learning model via the additional separate input interface in addition to the graphical input data. For example, a user can generate handwritten information on a printout. A user can also generate another object and/or labeling information and/or weighting information on a separate or superimposed graphic layer, which can be superimposed on vector graphics, for example, using a smart pen or smart pad or touchscreen or other input medium, such as a mouse or keyboard or the like. In such a graphic layer, a numerical value could be assigned to each pixel or group of pixels as a mask for generating weighting information, for example, by the user circling or outlining a specific region of interest or marking it in some other way. The weighting information for such a region can then be created, for example, by a segmentation algorithm such as region growing. The labeling information may comprise textual or numerical information. The labeling information may also be provided semi-automatically or automatically on the basis of the input data, in particular if, for example, a specific property or function can be assigned to an object based on its type or class, and then provided to the machine learning model via the additional separate input interface in addition to the graphical input data.

An object description preferably comprises information about an object that includes its characteristics, attributes, and/or properties. This may include physical characteristics (e.g., size, color, shape), functional characteristics (e.g., use, purpose), and other relevant details, functions, modes of action, or properties that preferably contribute to the identification and/or understanding of the object.

Object classification preferably refers to classifying objects into predefined categories, groups, and/or classes. This classification is preferably based on certain criteria and/or characteristics of the object and preferably serves to group similar objects, in particular logically or according to a ranking, and/or to distinguish them from other objects.

Interaction information preferably describes the relationships and/or interactions between at least two, in particular different, objects. This can include how objects interact with each other, influence each other, and/or are connected (effectively). Examples of this are physical interactions (e.g., objects that touch and/or move), logical relationships (e.g., hierarchies and/or networks), and/or functional relationships (e.g., one component that controls another). Interaction information can preferably be generated or provided graphically, for example by means of directional arrows or other graphic symbols. The interaction information can, for example, be provided manually by means of user input, in particular graphic and/or textual and/or linguistic input. Alternatively, the interaction information can also be automatically recognized in the input data on the basis of object recognition and/or effective connection recognition. For example, such interaction information can be extracted from image and/or video data by semantic segmentation, in particular by means of a convolutional neural network (CNN), whereby, for example, adjacent objects can be recognized as interacting, and interaction information can be generated on this basis. The interaction information can also be generated as metadata when the input data is generated.

The present method has the advantage that the weighted text output and/or speech output can be generated on the basis of the at least one at least one weighting information. It is thus possible, by assigning and/or specifying the at least one weighting information to objects or other information in the input data, to weight the text output to be generated in order, for example, to cause the at least one machine learning model, preferably a large language model, to name only such information or primarily such information or such information according to a ranking or order of importance in the weighted text output and/or speech output. In other words, the at least one weighting information can be used to define preferences with regard to the input data, on the basis of which the at least one text and/or speech output can be generated. This prevents information that is rather insignificant or undesirable with regard to the input data from being processed in the at least one text and/or speech output. In other words, it can be prevented that information that is significant and desirable with regard to the input data is not processed in the at least one text and/or speech output. This gives the at least one machine learning model at least one condition or restriction that must be taken into account, at least in the semantic generation of the text and/or speech output. This prevents the machine learning model, which has a large language model, from randomly generating a text and/or speech output for information contained in the input data, in which important information may be omitted, contexts may not be recognized or may be recognized incorrectly, and/or unimportant information may be mentioned. The at least one weighting information thus improves the accuracy of the text and/or speech output, measured against the input data that is to be automatically translated into text or speech. Furthermore, providing the at least one weighting information can increase the model performance of the at least one machine learning model, since a cost function or loss function can be optimized regarding the input data. The at least one machine learning model is preferably designed as a multimodal model, which is preferably designed for processing graphical input data and additionally also for processing textual and/or numerical input data and/or audio input data.

Separating the input layers allows for deterministic influence on the internal activation paths of the machine learning model. Metadata with weighting information acts preferably not as semantic commands, but as technical control parameters that flow directly into the internal calculation units during model initialization and the calculation of attention weights. The dual input architecture reduces interference between visual features and external control parameters that occurs in conventional multimodal models, where all inputs are routed through a common prompt or embedding path. Separate processing improves the reproducibility and stability of the model response and reduces the variance between multiple inference runs. The division into two input layers enables optimized load distribution between computing modules, as image processing and metadata processing can be performed independently of each other in parallel pipelines. This results in reduced latency and improved hardware utilization.

The present method and/or system may have a continuous technical processing chain comprising sensory or file-based acquisition of graphic data; separate input interfaces, each with its own validation modules; separate feature extraction in independent encoder modules; a fusion module for synchronized merging of the separate streams; and a decoder module for generating the text or speech output. In the fusion module, the weighting values provided by the second input interface can be used to control a gating mechanism that amplifies or attenuates individual feature channels of the visual encoder. This mechanism allows fine-grained modulation of information transfer between the encoder and decoder and establishes a technical coupling between the separate data streams based on purely numerical control variables.

The separate input paths also enable hardware-based assignment of the processing steps to independent computing units. In particular, the image data path can be executed on dedicated GPU shader or tensor cores, while the numerical weighting parameters are preprocessed on CPU cores or vector units. This parallel processing leads to improved resource utilization of the hardware platform, reduces latencies, and enables a technically measurable performance increase of the overall system. The physical or logical separation of the input paths also reduces the likelihood of memory interference, in particular cache coherence conflicts or data races between heterogeneous data streams. The clear assignment of input data to separate buffers and processing units leads to more stable memory management within the computing architecture and allows the system to use memory bandwidth more efficiently.

The architecture described enables adaptive prioritization of image regions based on externally provided control data, particularly in industrial processing systems, e.g., in automated assembly or production lines. This allows the system to generate real-time instructions or maintenance information with significantly less delay, which is a clear technical advantage, especially in safety-critical or time-critical applications.

The modular design of the separate input paths also allows the integration of additional sensor modalities, such as radar or lidar data, without changing the existing architecture. Each additional data stream can be integrated via its own technically separate input interface and input layer, which increases the scalability of the system and enables flexible adaptation to complex multisensory environments.

Conventional multimodal models process different data modalities via a common prompt channel or a common embedding path. The present method differs fundamentally in that it provides separate input classes with separate model paths, which enable explicit technical control of the model. Such a structure is not described in the known literature and system architecture of multimodal models. In contrast to known multimodal models, which merge all inputs into a common token or embedding structure, the solution described here provides for a persistent and technical separation of the modalities up to a definable fusion layer. This architectural separation represents a structural change to the ML pipeline and produces technical effects that are not addressed in the state of the art, particularly with regard to deterministic model control, hardware allocation, and the avoidance of cross-modality interference.

In a further aspect, it is proposed that the provision of the graphical input data comprises providing image data by scanning a sketch and/or graphic and/or drawing, in particular a technical one, from a user; and/or
providing image data and/or vector data, in particular a technical sketch and/or graphic and/or drawing, which can be created by a user using a program for graphical data processing; and/or
providing image and/or video data based on a camera or video recording made by means of an optical sensor.

Image data is preferably data that contains image information in the form of pixels or as vector graphics. The process of digitization to obtain the image data is preferably carried out by scanning using a scanner. The image data originates preferably from technical sketches, graphics, and/or drawings created by a user in paper format. These elements are converted into digital image data by the scanning process, which can then be processed by the present method, in particular by the at least one machine learning model, to generate the at least one text output.

Image data and/or vector data preferably describe digital data that contain raster images (image data) and/or mathematically defined graphics (vector data). The image data and/or vector data can preferably represent technical sketches, graphics, and/or drawings. The image data and/or vector data are preferably created by a user with the aid of software tools for graphical data processing (e.g., CAD programs, photo editing programs, graphics programs, presentation programs such as PowerPoint, planning programs that create time sequences such as Gantt charts or Unified Modeling Language, etc.). A standalone software tool for graphic data processing is also possible. In principle, it is also possible to generate the graphical input data using a machine learning model or an artificial intelligence algorithm to generate image data, such as DALL-E.

Image and/or video data are digital files that contain still images (photos) and/or moving images (videos). This data preferably originates from recordings made with a camera or video device. The image and/or video data is preferably captured by an optical sensor. The optical sensor can be a camera, a lidar sensor, a radar sensor, or an ultrasonic sensor.

For example, the present method can be used to provide image and/or video data as input data from a traffic situation. The image and/or video data can be captured, for example, by a traffic surveillance camera. The image and/or video data can provide, for example, recordings of a road intersection. In the event of a rear-end collision or other accident or traffic offense, it may be preferable for the image and/or video data to serve as input data in order to generate, for example, an automatic accident report as text output. In this case, the image and/or video data can be automatically preprocessed, for example, by the at least one machine learning model, for example, comprising a classification and/or semantic segmentation model, in order to automatically extract at least some of the objects and/or labeling information (e.g., vehicle type information, speed information, direction information, license plate information, traffic light switching information, traffic sign information, and/or road marking information, etc.) automatically from the image and/or video data. Furthermore, additional labeling information can preferably be supplemented manually or semi-automatically (e.g., by preselection suggestions) by a user. Furthermore, the user can provide the at least one weighting information for the objects and/or labeling information included in the image and/or video data, for example, via a correspondingly designed software tool. The at least one weighting information can be generated, for example, on the basis of the user's domain knowledge. Alternatively, the at least one weighting information can also be generated at least partially automatically by comparison with previously known weighting information, for example from similar life situations, by the at least one machine learning model or another comparison algorithm. The output text can then be generated automatically from the image and/or video data on the basis of the at least one weighting information by the at least one machine learning model, which has a generative language model ( ), for example, also a large language model (LLM), in order to generate, for example, an accident report or a crime report.

A similar procedure is also conceivable for automatically generating a statement of claim or a complaint as the text output, whereby image and/or video data, which can be pre-and/or post-processed accordingly, can preferably serve as input data here. Alternatively or in addition, a factual sketch with causal relationships and/or other markings can also serve as input data. Such a factual sketch can preferably be created using a corresponding software tool. Alternatively, such a factual sketch can also be provided in the form of a hand-drawn sketch, which is then digitized via a scanning process and can be provided as input data in the form of image data or vector data.

In a further aspect, it is proposed that the labeling information for the objects be provided:
by at least one graphical object property, in particular a size and/or shape and/or type and/or appearance, and/or
by a textual object label and/or by meta information; and
wherein the labeling information can be generated and/or processed at least partially automatically, in particular by comparing one of the objects included in the input data with previously known objects using the at least one machine learning model; and/or
wherein the labeling information can be generated at least in part by manual identification.

The size preferably describes the dimensions of an object. The shape preferably describes an external form and/or contour of an object. The type preferably describes a category or type of an object. The appearance preferably describes a visual representation of an object, which may include, for example, color and/or texture. A textual object label preferably describes descriptive and/or identifying text information that specifies an object in more detail. The meta information preferably describes additional data that provides context and/or additional information about the object. The meta information may, for example, comprise text information and/or numerical information that is not included in the input data in graphical form, but may be included in the input data in another way. The meta information may, for example, comprise a reference, in particular a reference to coordinates and/or reference marks, etc.

This labeling information can be generated automatically or processed and fed into the machine learning model via the additional interface in addition to the graphical input data. This is preferably done by comparing one of the objects contained in the input data with previously known objects using at least one machine learning model, which, for example, has a classification model and/or a semantic segmentation model. Other comparison algorithms that do not involve artificial intelligence are also conceivable. This comparison allows certain features to be detected automatically and assigned to at least some objects. Manual labeling is also possible. In addition or as an alternative, the labeling information can be generated by manual input and/or marking. This may be preferable if automatic recognition is insufficient or if additional, specific information is required that can be provided on the basis of specialist knowledge, for example. This approach enables flexible and comprehensive provision of labeling information, incorporating both automated and manual methods to enable precise and informative labeling of the input data. The markings that can be generated by the user can also be mapped as a two-dimensional mask tensor, whose values can be multiplied directly with the feature maps of the image-processing encoder layers. This operational integration of the mask values causes a physical-technical modulation of the signal strength in the early convolutional layers of the model and can thus represent a direct control of the image processing pipeline. The mask tensor can function as a technical control parameter rather than a semantic descriptor object.

In a further aspect, it is proposed that the object description has at least one object functionality and/or a range of functions, and/or
wherein the classification has an object class and/or an object type and/or an object group, and/or
wherein the interaction information comprises information on at least one causal relationship and/or a causal connection between at least two objects,
wherein the object description and/or classification and/or interaction information can be generated automatically or manually.

It is proposed that the object description should include at least one object functionality and/or a range of functions. This means, preferably, that the description of an object should include detailed information about the specific functions or the entire range of functions of the object. For example, this could include the tasks and/or capabilities of a device or software.

Furthermore, it is proposed that the classification should include an object class and/or an object type and/or an object group. This means, preferably, that each or at least some of the objects are classified into a category based on specific criteria. An object class could represent a broad category, such as “electronic devices” or “mechanical components,” while an object type could represent a more specific subcategory, such as “smartphone” or “shaft.” An object group can represent a collection of similar objects that can be grouped together based on common characteristics, such as at least several devices from a particular manufacturer and/or at least several objects with at least a similar range of functions and/or at least a similar mode of operation.

It is further proposed that the interaction information include information on at least one causal relationship and/or causal connection between at least two objects. This preferably means that detailed information is provided on how two or more objects interact and/or influence each other. A causal relationship could, for example, describe how a smartphone is synchronized with a smartwatch. A causal connection could describe in detail a specific type of communication (WiFi, Bluetooth, etc.) between these devices.

The object description and/or classification and/or interaction information can be generated partly automatically and/or partly manually. Automatic generation can be achieved through the use of algorithms and machine learning, whereby the relevant information can be collected and/or categorized independently. Manual generation may involve the direct input and/or maintenance of information by users or experts, which allows for flexibility and precision in the description.

In a further aspect, it is proposed that weighting information be provided for multiple objects and/or for multiple labeling information, and wherein the at least one machine learning model generates a ranking and/or sequence of a description, in particular a textual and/or auditory description, of the respective object and/or the respective labeling information in the generated, weighted text output and/or speech output on the basis of the respective weighting information.

It is therefore particularly preferred that weighting information be provided for at least some of the objects and/or labeling information. This makes it possible, for example, to assign the same weighting or importance to two or more objects and/or two or more pieces of labeling information. It is also possible to assign different weighting information to several objects and/or labeling information in order, for example, to establish a ranking or sequence of importance in which the objects and/or weighting information are mentioned in the at least one text output. This makes it possible, for example, to give preference to an object and/or labeling information for the generation of the text output by specifying the respective weighting information. On the other hand, by assigning the respective weighting information, it may be possible to specifically “hide” an object or labeling information or specifically not to describe it in the text output, even though it is present in the input data.

It is understood that weighting information does not have to be assigned to every object or piece of labeling information; for example, some objects and/or pieces of labeling information may be assigned no weighting information or “default” weighting information.

In a further aspect, it is proposed that the at least one machine learning model describe, on the basis of the respective weighting information, in particular according to at least a single-stage ranking, those objects and/or labeling information in the weighted text output that fulfill at least one predetermined weighting criterion.

In other words, for the generation of at least one text output, the information from the input data (preferably labeling information and/or object information and/or meta information) that meets a specific weighting criterion, for example, is weighted highly or low and can be processed preferably by the machine learning model or LLM. If several weighting criteria are available, a multi-stage creation or generation of textual descriptions of the input data can also take place, whereby the ranking can preferably be based on a gradation of the weighting information across several weighting criteria.

In a further aspect, it is proposed that the at least one machine learning model generate multiple text outputs or at least one multiple-subdivided text output based on the respective weighting information, depending on multiple weighting criteria.

In this way, it is possible, for example, to generate a text output in which the most important or highest-weighted labeling information and/or other information from the input data is reproduced textually first. In the same text output or a separate text output, further, but less highly weighted, labeling information and/or other information from the input data can then be reproduced in text form, in particular until all information from the input data for which weighting information exists has been processed or reproduced in text form. In a particularly preferred embodiment, the weighting criterion may have a weighting threshold or a gradation of weightings. A weighting interval is also conceivable.

In a further aspect, it is proposed that the at least one machine learning model comprise a large language model and/or a convolutional neural network and/or a transformer model and/or other model types.

The at least one machine learning model preferably comprises at least one large language model (LLM). In the present context, the term “large language model” collectively refers to all language models, in particular generative language models, such as BERT or similar, regardless of the number of degrees of freedom and/or parameters. In this way, the at least one text output can be automatically generated on the basis of the input data ( ) and/or the objects and/or the labeling information and the at least one weighting information. The at least one machine learning model may further comprise a classification model for classifying objects in graphical input data. The at least one machine learning model may further comprise a semantic segmentation model (such as Segment Anything or You Only Look Once). The at least one machine learning model may further comprise a hybrid model that comprises a model component that operates on the basis of artificial intelligence and a model component that comprises an analytical or statistical model. In principle, the at least one machine learning model may comprise any model type that is suitable for preprocessing (data pre-processing models), processing (data processing models), and/or postprocessing (data post-processing models) the input data in order to extract the labeling information and/or the objects at least partially automatically from the input data. The at least one machine learning model can be understood as an artificial intelligence algorithm. The at least one machine learning model can comprise a neural network, preferably a deep neural network. The machine learning model can preferably comprise a transformer model. The machine learning model can preferably comprise an encoder model. The machine learning model may preferably comprise a convolutional neural network (CNN). The machine learning model may preferably comprise a convolutional neural network (CNN) with a downstream decoder.

At least part of the labeling information and/or the object information can be extracted from the input data in the form of a knowledge graph. In this case, it may be preferable for the at least one machine learning model to comprise a graph-based neural network that is designed to process graph-like and/or tree-structured information (known as graph neural networks, GNNs). The representation or organization of the label information and/or the object information or the information about the objects as a knowledge graph or as a tree structure can preferably be generated automatically from user input and/or based on metadata or meta-information provided with the input data. The preparation of the labeling information and/or the object information or the information about the objects as a knowledge graph can be advantageous in order to facilitate or make more accurate the processing by an LLM for generating the text output, since the LLM can then, if necessary, describe the tree structure, including the nodes contained in the tree structure and their information content and/or their interactions or connections. The information from the knowledge graph can be transferred to an embedding space to be processed by the LLM to generate the output text.

The at least one machine learning model preferably comprises a linear model for processing vector data. Such a linear model may comprise linear regression, logistic regression, and/or other decision trees, such as random forest and ensemble methods. The at least one machine learning model preferably comprises a gradient boosting model, which describes an ensemble approach based on sequential improvements (e.g., XGBoost, LightGBM). The at least one machine learning model preferably comprises a k-nearest neighbors (KNN) model. The at least one machine learning model preferably also includes a support vector machine (SVM) model. The at least one machine learning model preferably includes a recurrent neural network (RNN), for example, also long short-term memory (LSTM), in order to specifically process sequential data and/or time-dependent features from the input data. The at least one machine learning model may preferably also comprise various clustering approaches, such as K-means and/or DBSCAN.

The at least one machine learning model can thus preferably comprise a plurality of models that can be used depending on the application and/or type and appearance of the input data in order to process all information from the input data, in particular graphical input data. The various models can be interconnected in order to provide, for example, a model output of one model as model input for another model.

The at least one machine learning model is preferably pre-trained in each case, so that, for example, an already pre-trained LLM can be used as a base model for the present application. The models are preferably not necessarily trained specifically for the present application for generating the text output. Instead, already trained models are preferred. Overall, however, the at least one machine learning model can be optimized, in particular on-the-fly or through active training, in order to continuously improve the quality or model performance(s) for generating the text output. For example, the quality of the text output can be evaluated and used to adjust the hyperparameters of the at least one model in order to increase the quality of the text output, in particular gradually. In the case of several or numerous machine learning models, isolated optimization of one or more of the machine learning models can be performed, in particular by solving a multi-layer optimization problem.

In a further aspect, it is proposed that the processing of the input data and/or the objects contained therein and/or the labeling information and the at least one weighting information by the at least one machine learning model comprises:
processing of graphical information of the input data and/or the objects contained therein and/or the labeling information and/or the at least one weighting information by classifying and/or segmenting by the at least one machine learning model and/or by capturing by at least one image pattern recognition algorithm and/or by a vector space comparison, in particular a vector space of a support vector machine and/or a vector space of a language embedding or the like, and/or by several image pattern recognition algorithms that differ from one another; and/or
processing textual information of the labeling information and/or the at least one weighting information by the at least one machine learning model.

If, for example, image and/or video data is provided as the input data, objects and/or other labeling information (e.g., interactions between objects) contained therein can be extracted, at least in part, by automatic classification and/or semantic segmentation using a corresponding classification model and/or segmentation model of artificial intelligence. Preferably, the information extracted in this way can also be curated manually, for example by a user, in order to verify the accuracy of the automatically recognized information. In this way, errors in the text output generated later can be prevented.

If, for example, the input data is provided in the form of vector data or vector graphics, the objects and/or other labeling information contained therein can preferably be extracted by a correspondingly trained machine learning model for processing vector data.

If the input (raw) data is provided via a physical medium, such as paper, it can be digitized by creating a scan. Such a scan or digital image of a physical graphic or representation, for example, a hand sketch, can then be further processed using an image pattern recognition algorithm to prepare the objects contained therein for classification and/or segmentation and/or further processing.

If the input data already contains text data, such as keywords and/or labels and/or names and/or other text information, it may be preferable, if such information is not already available in a machine-readable and/or machine-processable form, to convert it into such a machine-readable and/or machine-processable format using a text extraction algorithm, such as OCR recognition, into such a machine-readable and/or machine-processable format so that it can then be processed for text output, for example, directly or through the interposition of further processing steps (such as vectorization and/or text embedding generation, etc.) by the machine learning model, which may comprise an LLM. An embedding is preferably a mapping of tokens to numbers, preferably vectors, whereby an embedding can, for example, have contiguous tokens (in particular words, syllables, and/or word stems) and/or a vectorial proximity (vector norm, etc.). Thus, a kind of distance can be defined via the vector norm, for example. The LLM can preferably adapt the text information contained in the input data to a context and/or a concept that is preferably determinable and/or definable in order to preferably enable grammatically and/or syntactically and/or semantically correct terminology in the text output.

In a further aspect, it is proposed that the at least one at least one weighting information is provided by a user input, in particular a manual user input, or that the at least one at least one weighting information is generated at least partially automatically depending on at least one weighting criterion.

This means that the at least one at least one weighting information can preferably be provided in several different ways. On the one hand, the weighting information can be entered directly by a user. This is preferably done via user interfaces such as keyboards, touch screens, or other input devices. The user preferably has the option of entering specific weighting values and/or preferences, which are then taken into account or incorporated into the generation of the text output. This manual input allows the user to directly consider and adjust their specific needs and/or preferences. In this way, for example, the user's specialist knowledge and/or domain knowledge can be directly reflected in the input data through weighting information. This curates the input data in order to improve the quality of the text output generation. The manual provision of weighting information requires direct interaction by the user, but offers flexibility and customization options to suit the specific needs and/or preferences of the user.

Alternatively or additionally, the at least one weighting information can also be generated at least partially automatically, in particular on the basis of information from the graphical input data, and provided to the machine learning model via the further interface as additional metadata to the graphical input data separately from the graphical input data. This automatic generation preferably takes place depending on at least one weighting criterion. Weighting criteria could include various factors, such as historical data, user behavior, external conditions, limit values, limit intervals, and/or other specified algorithms. For example, the weighting information can also be evaluated based on the frequency with which objects and/or labeling information are included in the input data. If, for example, the same object is always included in several image data, this object can be automatically assigned a high weighting. If, on the other hand, objects and/or labeling information are only rarely present, for example, as determined by a threshold value, these objects and/or labeling information can be assigned a lower weighting. Multiple gradations, for example, by setting several threshold values, are also conceivable. A similar procedure can also be used with other meta information. For example, the at least one machine learning model can be set up to determine the objects and/or labeling information and/or other meta information and their variation from the input data itself in order to suggest at least one weighting information to the user, for example. These criteria can be analyzed, and the weighting information calculated from them, preferably enabling consistent and/or objective weighting of the labeling information and/or the objects and/or other (meta) information that may be included in the input data. The automatic generation of the weighting information may be more efficient and consistent, as it is based on objective data and defined rules. This reduces manual effort and minimizes potential user errors.

In a further aspect, it is proposed that the machine learning model comprise a large language model (LLM), wherein, if the at least one labeling information comprises textual information, the textual information is semantically abstracted by the LLM and/or adapted to a conceptual or contextual context of the input data and/or the text output.

The at least one LLM preferably abstracts the at least one piece of textual information semantically, i.e., the LLM elevates the meaning of the text elements to a higher level and preferably extracts essential concepts. The textual information is preferably adapted by the LLM to the conceptual context of the input data, whereby the meaning of the information is understood and interpreted in a broader context. The textual information is preferably adapted by the LLM to the contextual context of the text output. This means that the information is modified in relation to the specific application or usage context in order to enable a precise and relevant representation, whereby it is preferable to access the comprehensive knowledge of the LLM, which has been trained on the basis of millions of text data in particular. These features make it possible not only to understand textual information in the input data, but also to adapt it to the relevant context and deliver a semantically accurate and contextually appropriate representation and formulation. This can improve the linguistic quality of the text output, even if the input data contained terms and/or names that were distant from the context and/or concept.

In a further aspect, it is proposed that the machine learning model comprise a CNN and a decoder. The decoder is preferably connected directly or indirectly downstream of the CNN or attached to it. The decoder thus receives, for example, the output data from the CNN for further processing. In this way, text and/or image data and/or structured data can be entered as input data in order to then generate the at least one text output. The at least one text output can preferably also include an image component and/or other structured data in order to generate, for example, a form or similar as text output based on the at least one weighting information.

In a further aspect, a computer program product is proposed, comprising commands that, when the program is executed by a computer, cause the computer to execute the steps of the present method in one of its aspects.

The computer program product preferably comprises a collection of instructions written in one or more programming languages and preferably designed to perform the tasks and/or functions described in the method when executed by a computer. The instructions in the program are preferably designed to cause the computer to go through and perform the various steps and sequences of the method according to the specified aspects.

In a further aspect, a computer-readable data carrier is proposed on which such a computer program product is stored.

This computer-readable data carrier may comprise various physical media, such as CDs, DVDs, USB sticks, hard disks, or semiconductor memories, e.g., SSDs, which can be read by computers or similar electronic devices. The computer program product stored on the data carrier preferably comprises a collection of instructions or code that can be executed by a computer to perform specific functions or tasks. The program may be written in various programming languages and contain different components such as executable files, libraries, configuration files, and documentation. The data carrier preferably enables the computer to read and execute the program stored on it in order to perform the intended functions.

In a preferred embodiment, a method for automatically generating a weighted text output in the form of an accident report and/or a factual report and/or a damage report and/or an insurance report and/or an expert report based on video data is proposed. The method comprising:
providing video data comprising objects of a traffic scenario via an input interface to at least one machine learning model;
providing labeling information for at least one of the objects and weighting information for at least one of the objects and/or for at least one of the labeling information via a further input interface of the at least one machine learning model as additional metadata to the video data, wherein the labeling information comprises a respective object description and/or classification and/or interaction information between objects, wherein the labeling information and the weighting information are preferably created by a user immediately upon viewing the video data via an input medium, and wherein the at least one weighting information comprises or defines a ranking and/or an importance and/or a sequence for the at least one of the objects and/or for the at least one of the labeling information; and
processing the input data, the labeling information, and the at least one weighting information by the at least one machine learning model to generate the text output weighted on the basis of the weighting information.

In a preferred embodiment, a method for automatically generating a weighted text output in the form of intellectual property claims based on graphic image data is proposed. The method comprising:
providing graphic image data comprising objects by which the property right can be described via an input interface, such as a graphic software tool, to at least one machine learning model;
providing labeling information for at least one of the objects and at least one weighting information for at least one of the objects and/or for at least one of the labeling information via a further input interface of the at least one machine learning model as additional metadata to the graphic image data, wherein the labeling information and the at least one weighting information are created by a user using domain knowledge in addition to the image data, wherein the labeling information comprises a respective object description and/or classification and/or interaction information between objects, and wherein the at least one weighting information comprises or defines a ranking and/or importance and/or sequence for the at least one of the objects and/or for the at least one of the labeling information; and
Processing the image data, the labeling information, and the at least one weighting information by the at least one machine learning model to generate the text output weighted on the basis of the weighting information. The method preferably comprises generating the text output weighted on the basis of the weighting information.

In a preferred embodiment, a method for automatically generating a weighted text output and/or speech output in the form of assembly instructions or disassembly instructions based on image data and/or video data is proposed. The method comprising:
providing image data and/or video data comprising objects to be assembled or disassembled and showing assembly or disassembly via an input interface of at least one machine learning model;
providing labeling information for at least one of the objects and at least one weighting information for at least one of the objects and/or at least one of the labeling information via a further input interface of the at least one machine learning model as additional metadata to the image data and/or the video data, wherein the labeling information and the at least one weighting information are created by a user using domain knowledge in addition to the image data and/or the video data, in particular while the user is viewing the image data and/or video data, wherein the labeling information comprises a respective object description and/or classification and/or interaction information between objects, and wherein the at least one weighting information comprises or defines a ranking and/or an importance and/or a sequence for the at least one of the objects and/or for the at least one of the labeling information; and
processing the image data and/or video data, the labeling information, and the at least one weighting information by the at least one machine learning model to generate the text output and/or speech output weighted on the basis of the weighting information. The method preferably includes generating the text output and/or speech output weighted on the basis of the weighting information.

The aspects described and their further developments can be combined with each other as desired.

Further possible embodiments, further developments, aspects, and/or implementations of the invention also include combinations of the aforementioned features or features to be explained below that are not explicitly mentioned. “One” is understood here as “at least one” or “at least one.”

When “text output” or “speech output” is written here, this is preferably understood to mean “text and/or speech output.” When “weighting information” is written, this is understood to mean “at least one weighting information” or “weighting information.” The latter also applies to all other features mentioned that are referred to in the singular. In this context, the term “objects” is also preferably understood to mean that the input data may comprise only one object or several objects.

### BRIEF DESCRIPTION OF DRAWINGS

The accompanying drawings are intended to provide a further understanding of the aspects of the invention. They illustrate embodiments and serve with the description to explain the principles and concepts of the invention.

Other aspects and at least several of the present advantages are apparent from the accompanying drawings. The elements shown therein are not necessarily shown to scale in relation to each other.

FIG. 1 shows a schematic flowchart of an embodiment of the present method.

FIG. 2 shows a schematic view of an application of the present method in one of its embodiments.

FIG. 3 shows a schematic view of one application of the present method in one of its embodiments.

FIG. 4 shows a schematic view of an application of the present method in one of its embodiments.

FIG. 5 shows a schematic view of an exemplary device.

FIG. 6 shows another schematic view of an exemplary device.

### DETAILED DESCRIPTION

In the figures of the drawings, identical reference symbols denote identical or functionally identical elements, parts, and/or components, unless otherwise specified.

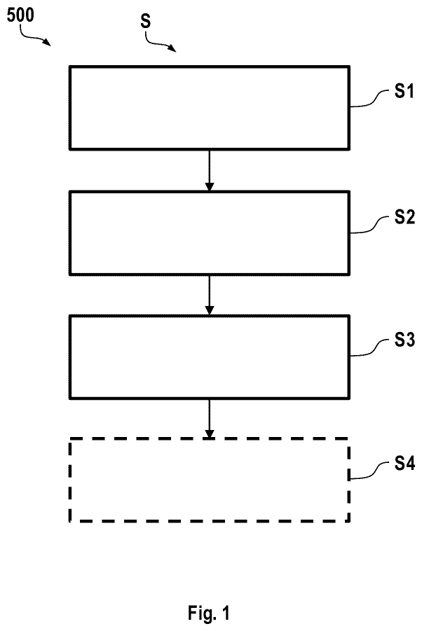

FIG. 1 shows a schematic flowchart of a method S for automatically generating a weighted text output and/or speech output based on input data.

The method S is preferably computer-implemented. In other words, the method S is preferably executable by means of a computer or a data processing device. The method S can also be executable in such a way that it is executable as a web application, i.e., it can be executed on a server or in a cloud, for example.

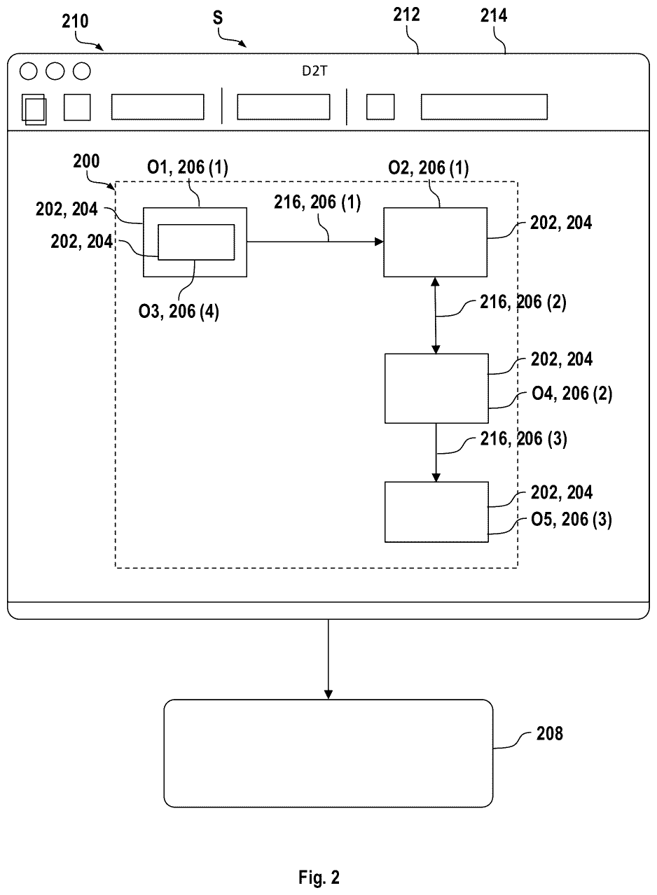

The method S comprises (also about FIGS. 2 to 4) at least the following steps:

In step S1, graphical input data 200, 300, and 400, comprising objects 204, 304, and 404, is provided via an input interface 514 to at least one machine learning model 505.

In step S2, labeling information 202, 302, and 402 for at least one of the objects 204, 304, and 404 and weighting information 206, 306, and 406 for at least one of the objects 204, 304, and 404 and/or to at least one of the labeling information 202, 302, and 402 via a further input interface 516 of the at least one machine learning model 505 as additional metadata to the graphical input data 200, 300, 400. The labeling information 202, 302, 402 has, for example, a respective object description and/or classification and/or interaction information between objects 204, 304, 404. The at least one weighting information 206, 306, 406 comprises a ranking and/or an importance and/or a sequence for the at least one of the objects 204, 304, 404 and/or for the at least one of the labeling information 202, 302, 402.

In step S3, the input data 200, 300, 400 and/or the objects 204, 304, 404 and the labeling information 202, 302, 402 and the at least one weighting information 206, 306, 406 are processed by the at least one machine learning model 505 to generate the text output and/or speech output 208, 308, 408 weighted on the basis of the weighting information 206, 306, 406.

In step S4, the method comprises generating the text output and/or speech output 208, 308, 408 weighted on the basis of the weighting information 206, 306, 406.

FIG. 2 shows a schematic view of an application of the present method in one of its embodiments. The method is executed within the framework of a software tool 210, which is schematically visualized in FIG. 2. The software tool 210 is visualized by showing a schematic view of a user interface 212. The software tool 210 is designed as a program for graphical data processing 214 and can be used by a user to create image data and/or vector data that can serve as the graphical input data 200 for the present method and that is provided to the machine learning model 505 via the input interface 514. The present software tool 210 can basically be provided as a plug-in software tool and can be connected, for example, to computer-aided design (CAD) software. Integration into computer-aided manufacturing (CAM) software and/or computer-aided engineering (CAE) software is also conceivable. The present software tool 210 can also be provided as a plug-in solution for a program for graphical data processing 214, such as PowerPoint® from the manufacturer Microsoft®. Alternatively, the software tool can also be designed as a stand-alone solution, which can be executed, for example, as a desktop application or as a web application.

Using the software tool 210, the user can, for example, generate a technical sketch and/or graphic and/or drawing and/or flowchart or the like, as shown schematically in FIG. 2. The user can then preferably generate labeling information 202, for example, for at least one object 204, for the image data and/or vector data generated in this way. The labeling information 202 can, for example, comprise textual and/or numerical data and/or audio data. The labeling information 202 may comprise a respective object description and/or classification O1, O2, O3, O4, O5 and/or interaction information 216 between objects 204. The respective object descriptions O1, O2, O3, O4, and O5 may comprise at least one object functionality and/or a range of functions. The object classification may comprise an object class and/or an object type and/or an object group. The respective interaction information 216 may comprise information on at least one causal relationship and/or a causal connection between at least two objects 204. In the present case, the labeling information 202 and the interaction information 216 for the objects 204 can be generated by the user via corresponding user input into the software tool 210 and provided to the machine learning model 505 via the additional input interface 516 as additional metadata in addition to the graphical input data 200, 300, and 400. In other embodiments, the labeling information 202 can also be generated at least partially automatically, for example, by attachments of an object 204, loaded from a database of the software tool 210, for example, and provided to the machine learning model 505 via the further input interface 516 separately and in addition to the graphical input data 200, 300, and 400. Objects 202 may also already be assigned certain labeling information 202, for example, based on their shape and/or function and/or their graphical appearance, which is provided to the machine learning model 505 separately and in addition to the graphical input data 200, 300, 400 via the further input interface 516. For example, an arrow may already provide interaction information 216 about a type of interaction between the objects 204, for example, based on a creation origin and a termination. The same applies to any objects 204 whose labeling information 202 can be stored or retrieved, at least in part, for example, in a database. The respective object 204 and the respective labeling information 202 are preferably each assigned weighting information 206, which can be created by the user, in particular by manual entry via a user interface. When the object 204 or the labeling information 202 is created, the assignment can initially be set to a specific value by default and then be specifically changed by the user. Alternatively, the weighting information 206 can also be stored together with an object 204 and/or labeling information 202 and made available to the machine learning model 505 separately from the graphical input data 200, 300, 400 via the additional input interface 516. In this case, the weighting information 206 is determined by numerical values. The value 1 describes the highest weighting. The value 2 describes a lower weighting. The value 3 describes a lower weighting than the value 2. The value 4 describes a lower weighting than the value 3. The respective weighting information 206 is shown in FIG. 2 in brackets after the respective reference symbol 206.

Based on the input data 200, the designed software tool 210 is now to generate a text and/or speech output 208. The graphical input data 200 created or provided by the user via the software tool 210 and/or the created objects 204 are provided to the machine learning model 505 via the input interface 514. The created and/or curated labeling information 202 and the respective weighting information 206 are provided to the machine learning model 505 separately from the graphical input data 200 via the additional input interface 516. The graphical input data 200, the labeling information 202, and the weighting information 206 are then processed by the at least one machine learning model, for example, a transformer-based LLM, in such a way that at least one weighted text output and/or speech output 208 is generated on the basis of the at least one weighting information 206 and preferably on the basis of the associated further information from the labeling information and the graphical input data 200.

For example, the following text output 208 is generated for the input data 200 from FIG. 2, whereby the large language model (LLM) initially only processes information that has been assigned weighting (1):

“Object O1 is assigned to object class X and is designed to send information to object O2, whereby object O2 is designed to process the information.”

In a further exemplary stage, which is determined by the weighting (2), the text output 208 can then be expanded, or a new text output 208 can be generated, for example:

“Object O2 is in a bidirectional information exchange with object O4, whereby object O4 is designed to further process the information from O2. Object class X is designed to send information to object O2, whereby object O2 is designed to process the information.”

In a further exemplary stage, which is determined by the weighting (3), the text output 208 can then be expanded, or a new text output 208 can be generated, for example:

“Object O4 is configured to send the further processed information to object O5, wherein object O5 is configured to output the information O5.”

In a further exemplary step determined by the weighting (4), the text output 208 can then be expanded, or a new text output 208 can be generated, for example:

“Object O1 comprises object O3, whereby object O3 is designed to store the information from O1.”

Based on such weighting information 206, it is thus possible to generate specifically weighted text outputs 208. Similarly to what was described above, it may also be possible to automatically generate assembly instructions based on a technical drawing, in particular an exploded view. The text and/or speech output can preferably also be combined with an augmented reality (AR) application, for example, AR glasses and/or AR lenses, in order to accompany and support a user, in particular step by step, during the assembly of a product by means of the auditory and/or textual accompaniment provided by the text and/or speech output. In general, the method for generating the weighted text output 208 can also be used to generate a technical description of a technical object and/or process based on a technical drawing, a sketch, a graphic, and/or a flowchart, which serve as input data 200.

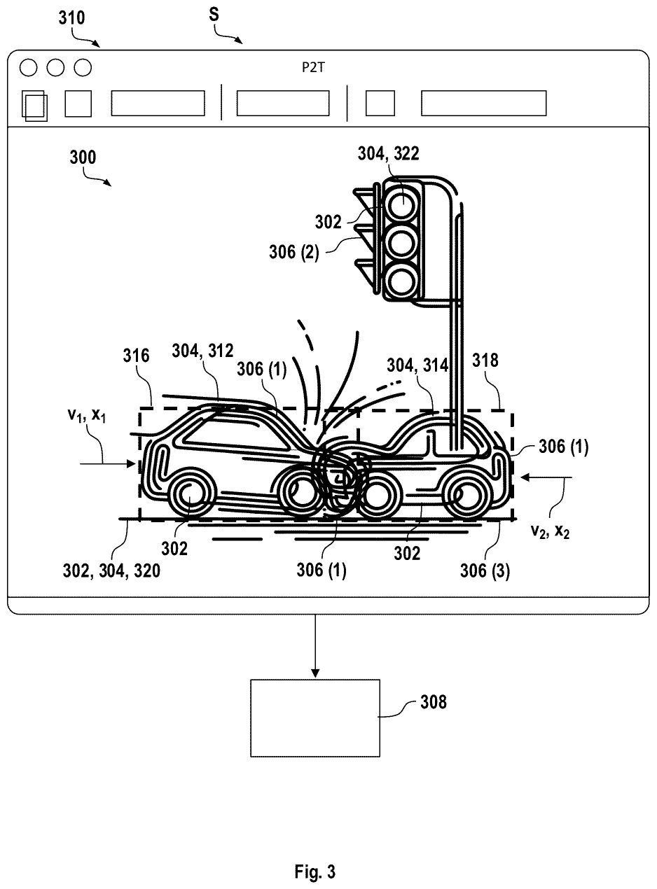

FIG. 3 shows a schematic view of an application of the present method in one of its embodiments. In this case, image and/or video data can be processed as the graphical input data 300 via an input interface 514 by the machine learning model 505 using a suitably designed software tool 310. As an example, the image and/or video data shows a recording of a road intersection at which two vehicles, 312, 314 collided with each other due to at least one of the vehicles disregarding a traffic rule. The at least one machine learning model 505, which in the present case may comprise, for example, a classification model and/or a semantic segmentation model, can be used to automatically recognize the vehicles 312, 314 or the objects 304 as such and, if necessary, segment them by generating bounding boxes 316, 318 (for example, by a pre-trained CNN, preferably in combination with a decoder), whereby, in particular, speed and/or direction information can also be determined as the labeling information 302 from the image data or video data, in particular successive image data or video data, in particular by vector flow analysis. Such labeling information is then provided to the machine learning model 505 via the further input interface 516 as additional metadata to the graphical input data 200, 300, 400 in order to be processed as additional input variables by the machine learning model 505 to generate a more qualified output. The at least one machine learning model 505 can also extract further objects 304 and/or associated labeling information 302 from the image and/or video data, for example, a road 320 (with labeling information such as surface condition, weather conditions, etc.) and/or a traffic light 322 (with labeling information such as switching position, switching time, etc.) can also be extracted. Similarly, information can also be extracted from traffic signs, for example, a direction of travel indication or a diversion symbol, etc.

The extraction of objects 304 and, in particular, their labeling information 302 can also be supported by a user using the software tool 310. This can be advantageous if, for example, domain knowledge and/or expert knowledge is to be incorporated into the identification. The user can preferably specify weighting information 306 for the objects 304 and/or the respective labeling information 302, in particular by manual input via mouse or keyboard or touch device. In this case, the user defines the weighting information 306 as follows: Vehicle 312 (object 304) with speed v1 and direction x1 (labeling information 302) has weighting (1). Vehicle 314 (object 304) with speed v2 and direction x2 (labeling information 302) has weighting (1). Further weighting information 306 can be specified with (1) for an overlap area of the bounding boxes 316, 318 in order to determine a collision location (for example, in the overlap area of the bounding boxes 316, 318). Traffic light 322 (object 304) with traffic light switching position and switching time (labeling information 302) has weighting (2). Road 320 (object 304) with surface condition and weather condition information (labeling information 302) has weighting (3).

Based on this information, in addition to the graphical input data 300, the weighting information 306 can now be used to automatically generate an improved text output 308, in particular in the form of an accident report.

An example of such a text output 308 could be:

“Vehicle 1 was traveling at a speed of v1 in the direction of x1 when it collided with vehicle 2, which was traveling at a speed of v2 in the direction of x2 at location X.

At the time of the collision, the traffic light for vehicle 2 was red, with the switching time being X seconds before the collision.

At the time of the accident, the road was dry and the surface was intact, so that no road surface-specific restrictions for vehicle 2 could be determined.”

In the case of such an accident report being generated from image and/or video data, it may also be preferable for the LLM to be retrained with country-specific legal texts and/or legal decisions in order to incorporate such specific knowledge when generating the text output 308. This allows the text output 308 to be supplemented with an addition, for example:

“No relevant mitigating objective circumstances are apparent.”

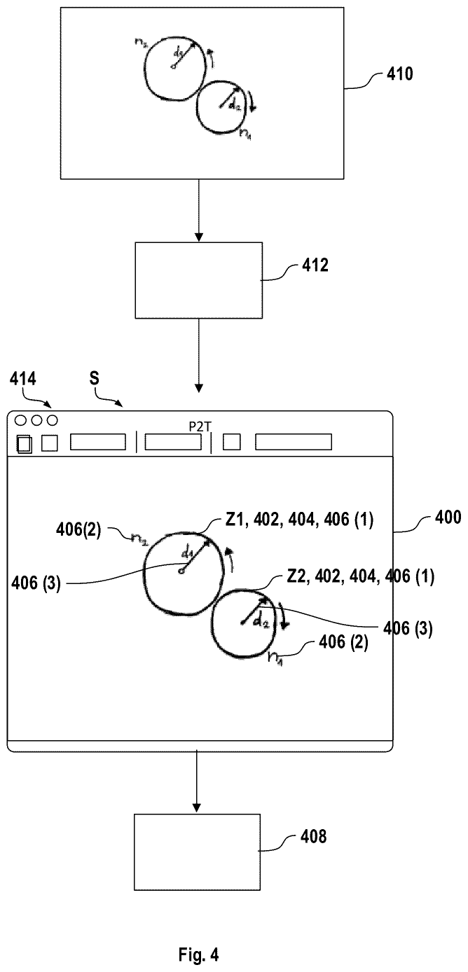

FIG. 4 shows a schematic view of an application of the present method in one of its embodiments. A user can first provide the graphical input data 400 in the form of raw data 410, for example, as a hand sketch on paper. The raw data 410 is preferably digitized using a scanning device 412. The objects 404 contained in the raw data 410 can preferably be extracted from the now digital graphical input data 400 following the scanning process using the machine learning model 505, in particular comprising a classification model and/or a semantic segmentation model. It is also possible to extract the information (objects, labeling information, and/or other meta-information) contained in the input data 400 digitized by the scan using at least one image pattern recognition algorithm and/or vector space matching and/or several different image pattern recognition algorithms. In a corresponding software tool 414, which may be the software tool 210 shown schematically in FIG. 2, the input data 400 digitized and preprocessed in this way can then preferably be curated again by a user and/or supplemented with labeling information 402. For example, the weighting information 406 for the objects 404 and/or the labeling information 402 can be created. However, the weighting information 406 can also be included in the raw data 410, for example, as numerical values or by coloring or in some other way, and can be extracted at least partially automatically from the digitized graphical input data 400. It is important that the labeling information 402 and the weighting information 406 are not made available to the machine learning model 505 for further processing together with the graphical input data 400, but are fed to the machine learning model 505 as additional input variables via the additional input interface 516.

In the example shown, two gear wheels are schematically shown as the objects 404. In addition to the objects Z1, Z2, and 404, the raw data 410 also contains additional labeling information 402 as a mixture of numerical data and text data, which has been converted into machine-readable form, for example, by an image pattern recognition algorithm (e.g., OCR or similar), so that it can be (further) processed by the software tool 414. For object Z(1), the labeling information 404, n2, d1, and a direction of rotation (corresponding to interaction information) were specified in the raw data 410. For object Z2, the labeling information 404, n1, d2, and a direction of rotation (corresponding to interaction information) were specified in the raw data 410. The user can now specify weighting information 406 for each of the objects and labeling information 404. The value 1 describes the highest weighting. The value 2 describes a lower weighting. The value 3 describes a lower weighting than the value 2.

Based on this information, at least one weighted text output 408 can now be generated.

For example, the following text output 408 is generated for the input data 400 from FIG. 4, whereby the LLM initially only processes information that has been assigned a weighting of (1):

“Gear Z1 meshes with gear Z2.”

In a further exemplary stage, which is determined by the weighting (2), the text output 408 can then be expanded, or a new text output 408 can be generated, for example:

“Gear Z1 has a number of teeth n2. Gear Z2 has a number of teeth n1. The number of teeth n1 is smaller than the number of teeth n2.”

In a further exemplary step, which is determined by the weighting (3), the text output 408 can then be expanded, or a new text output 408 can be generated, for example:

“The gear Z1 has a diameter d1. The gear Z2 has a diameter d2. The diameter d2 is smaller than the diameter d1.”

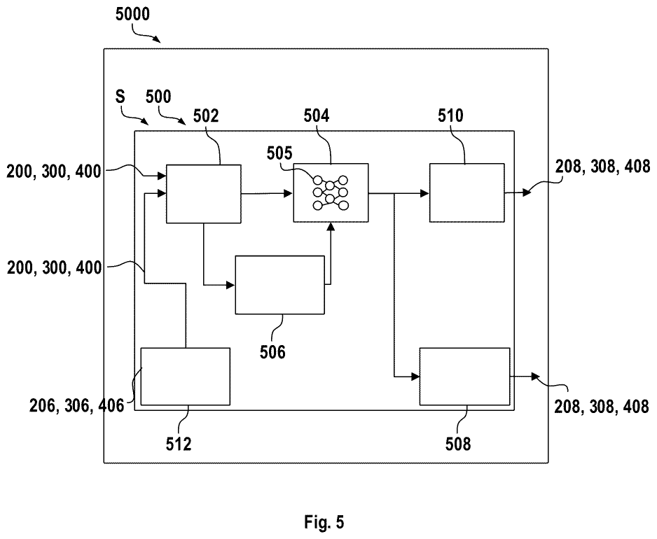

FIG. 5 shows a schematic view of an exemplary device 500. The method S can be performed in any aspect by the device 500.

The device 500 may comprise several components, for example, one or more provisioning devices 502 and/or at least one evaluation and computing device 504. It is understood that the provisioning device 502 may be designed together with the evaluation and computing device 504, or may be different from it. The device 500 may also be part of a system 5000. The device 500 may further comprise a storage device 506 and/or an output device 508 and/or a display device 510 and/or an input device 512.

The input device 512 may transfer the input data 200, 300, 400 to the provisioning device 502. The input device 512 can also be used to provide the at least one weighting information 206, 306, 406 for the graphical input data 200, 300, 400. For this purpose, the input device 512 may, for example, comprise a keyboard and/or a mouse and/or a touchpad and/or any other user input device.

The provisioning device 502 may also comprise the input device 512, or vice versa. The provisioning device 502 may also provide the input data 200, 300, 400. The provisioning device 502 may provide the graphical input data 200, 300, 400 to the evaluation and computing unit 504. The provisioning device 502 can also (temporarily) store the graphical input data 200, 300, 400 in the storage device 506. The storage device 506 can provide the graphical input data 200, 300, 400 to the evaluation and computing unit 504.

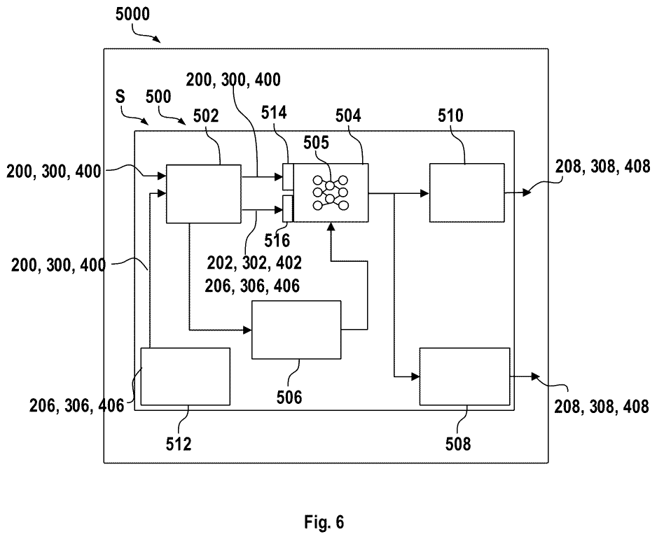

The evaluation and computing unit 504 may be configured to process the graphical input data 200, 300, 400 and/or the objects 204, 304, 404 and/or the labeling information 202, 302, 402 and the at least one weighting information 206, 306, 406 by the at least one machine learning model 505 and to generate the at least one weighted text output and/or speech output 208, 308, 408 based on the weighting information 206, 306, 406. For this purpose, the graphical input data 200, 300, 400 are provided to the machine learning model 505 via the input interface 514 (see FIG. 6). The input interface 514 can be designed as an input layer of the machine learning model 505. The labeling information 202, 302, 402, which is created and/or curated by the user and/or also generated automatically in some cases, and the at least one weighting information 206, 306, 406 are provided to the machine learning model 505 via the further input interface 516 for further processing (see FIG. 6). The further input interface 516 can be designed as a further, separate input layer of the machine learning model 505. The input interface 514 is designed separately from the additional input interface 516. The text output and/or speech output 208, 308, 408 can be output via the output device 508 and/or the display device 510 in visual and/or auditory and/or physical form (e.g., as a physical printout).

### REFERENCE SYMBOL LIST

200 Input data
202 Labeling information
204 Objects
206 Weighting information
208 Text output and/or speech output
210 Software tool
212 User interface
214 Graphical data processing program
216 Interaction information
300 Input data
302 Labeling information
304 Objects
306 Weighting information
308 Text output and/or speech output
310 Software tool
312 Vehicle
314 Vehicle
316 Bounding box
318 Bounding box
320 Street
322 Traffic light
400 Input data
402 Labeling information
404 Objects
406 Weighting information
408 Text output and/or speech output
410 Raw data
412 Scanning device
414 Software tool
500 Device
502 Provisioning device
504 Computing device
505 Machine learning model
506 Storage device
508 Output device
510 Display device
512 Input device
514 Input interface
516 Additional input interface
d1 Diameter
d2 Diameter
n1 Number of teeth
n2 Number of teeth
O1 Object description and/or classification
O2 Object description and/or classification
O3 Object description and/or classification
O4 Object description and/or classification
O5 Object description and/or classification
S Procedure
S1 Step “Provide”
S Step “Deploy”
S3 Step “Processing”
S4 Generate step
v1 Speed
v2 Speed
x1 Direction
x2 Direction
Z1 Object
Z2 Object

1. A method for automatically generating a weighted text output and/or speech output based on input data; the method comprising:
providing graphical input data comprising objects via an input interface of at least one machine learning model;
providing labeling information for at least one of the objects and at least one weighting information for at least one of the objects and/or at least one of the labeling information via a further input interface of the at least one machine learning model as additional metadata to the graphical input data, wherein the labeling information comprises a respective object description and/or classification and/or interaction information between objects, and wherein the at least one weighting information comprises a ranking and/or an importance and/or a sequence for the at least one of the objects and/or for the at least one of the labeling information; and
processing the graphical input data, the labeling information and the at least one weighting information by the at least one machine learning model to generate the text output and/or speech output weighted on the basis of the at least one weighting information.

2. The method according to claim 1, wherein the provision of the graphical input data comprises: providing image data by scanning a technical sketch and/or graphic and/or drawing of a user; or
providing image data and/or vector data, which can be created by a user using a program for graphical data processing; or
providing image and/or video data based on a camera or video recording made by means of an optical sensor.

3. The method according to claim 1, wherein the labeling information relating to the objects is provided:
by at least one graphical object property including a size and/or shape and/or type and/or appearance, and/or
by a textual object label and/or by meta information; and
wherein the labeling information can be generated and/or processed at least partially automatically by matching one of the objects included in the input data with known objects using the at least one machine learning model; and/or
wherein the labeling information can be generated at least partially by manual labeling.

4. The method according to claim 1, wherein the object description comprises at least one object functionality and/or a range of functions, and/or
wherein the classification comprises an object class and/or an object type and/or an object group, and/or
wherein the interaction information comprises information on at least one interactive relationship and/or interactive connection between at least two objects,
wherein the object description and/or classification and/or interaction information can be generated automatically or manually.

5. The method according to claim 1, wherein a weighting information is provided for each of a plurality of objects and/or a plurality of labeling information, and
wherein the at least one machine learning model generates, on the basis of the respective weighting information, a ranking and/or sequence of a description, by a textual and/or auditory description, of the respective object and/or the respective labeling information in the generated, weighted text output and/or speech output.

6. The method according to claim 5, wherein the at least one machine learning model describes, based on the respective weighting information according to at least a single-stage ranking, those objects and/or labeling information in the weighted text output that fulfill at least one predetermined weighting criterion.

7. The method according to claim 5, wherein the at least one machine learning model generates multiple text outputs or at least one multiple-subdivided text output based on the respective weighting information as a function of multiple weighting criteria.

8. The method according to claim 1, wherein the at least one machine learning model comprises a large language model and/or a convolutional neural network and/or a transformer model.

9. The method according to claim 1, wherein the processing of the input data and/or the objects contained therein and/or the labeling information and the at least one weighting information by the at least one machine learning model comprises:
processing graphical information of the input data and/or the objects contained therein and/or the labeling information and/or the at least one weighting information by classifying and/or segmenting by the at least one machine learning model and/or by detecting by at least one image pattern recognition algorithm and/or by a vector space comparison and/or by a plurality of image pattern recognition algorithms that differ from one another; and/or
processing textual information of the labeling information and/or the at least one weighting information by the at least one machine learning model.

10. The method according to claim 1, wherein the at least one weighting information is provided by a user input, or wherein the at least one weighting information is generated at least partially automatically as a function of at least one weighting criterion.

11. The method according to claim 1, wherein the machine learning model comprises a large language model (LLM), wherein, if the at least one labeling information comprises textual information, the textual information is semantically abstracted by the LLM and/or adapted to a conceptual or contextual relationship of the input data and/or the text output.

12. The method according to claim 1, wherein the input interface for the graphical input data comprises a first input layer of the machine learning model, wherein the further input interface comprises a second input layer of the machine learning model, and wherein the first input layer differs from the second input layer.

13. A computer program product comprising instructions that, when the program is executed by a computer, cause the computer to perform the steps of the method according to claim 1.

14. A computer-readable data carrier on which the computer program product according to claim 13 is stored.

15. A device for automatically generating a weighted text output and/or speech output based on input data, wherein the device comprises an evaluation and computing unit that is designed to perform the following steps:
providing graphical input data comprising objects via an input interface of at least one machine learning model;
providing labeling information for at least one of the objects and at least one weighting information for at least one of the objects and/or for at least one of the labeling information via a further input interface of the at least one machine learning model as additional metadata to the graphical input data, wherein the labeling information comprises a respective object description and/or classification and/or interaction information between objects, wherein the at least one weighting information comprises a ranking and/or an importance and/or a sequence for the at least one of the objects and/or for the at least one of the labeling information; and
processing the graphical input data, the labeling information and the at least one weighting information by the at least one machine learning model to generate the text output and/or speech output weighted on the basis of the at least one weighting information.

16. The method according to claim 2, wherein providing image data and/or vector data, is a technical sketch and/or graphic and/or drawing, which can be created by a user using a program for graphical data processing.

17. The method according to claim 10, wherein the at least one weighting information is provided by a user input is by a manual user input.
